(19) United States
(12) Patent Application Publication
(10) Pub. No.: US 2008/0178214 A1
(43) Pub. Date: Jul. 24, 2008

(54) Context relevant controls

(75) Inventor: Vishnu Kumar Shivaji-Rao, Vancouver, WA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 11/655,604

(22) Filed: Jan. 19, 2007

(51) Int. Cl. H04N 5/445

(52) U.S. Cl. 725/37

(57) ABSTRACT

Adjustment of operating parameters for an electronic device are enabled if the parameters are relevant to the source of the device's input signal and a user desired level of control of the device.

### CROSS-REFERENCE TO RELATED APPLICATIONS

Not applicable.

### BACKGROUND OF THE INVENTION

The present invention relates to electronic devices and, more particularly, to a system and method for adjusting an electronic device such as a television set.

Televisions and other consumer electronic devices have become more complex making set up and adjustment more difficult. For example, a television set may provide video and audio output for analog or digital over-the-air broadcast television signals derived from an antenna and/or a cable or a satellite receiver. In addition, the television may be the audio and visual output device for a digital versatile disk (DVD) player; a video cassette recorder (VCR); a personal video recorder, an electronic game console, a personal computer (PC) and/or other devices that output audio and/or video signals. With a television set, a user can watch and record television programming, watch and record movies, play video games and communicate over a data network using a device that provides a large visual display and high quality sound.

An operating manual is typically provided with a television set and each of the peripheral devices that may be connected to the television set. Operating manuals are often lengthy because of the wide variety of optional sources of input signals for a television set. In addition, the content of the manuals available for a television installation is often confusing because the television set and the peripherals to be connected to the television are obtained from different sources each with its own view on the layout and terminology useful for understanding the equipment it supplies. To aid users in optimizing the performance of their television set following set up or connection to one of the broad range of peripheral devices, many television sets provide a system of on-screen menus enabling the user to display an adjustable control for a number adjustable operating parameters. However, menu systems typically display a consistent number and arrangement of operating parameters without regard to whether adjustment of a parameter is applicable when the television is connected to a particular input and without regard to the user's desire to control certain aspects of the television's operation.

What is desired, therefore, is a menu system for a television that enables adjustment of the television's operating parameters that are appropriate to the source of the input signal and the level of control desired by the user.

### BRIEF DESCRIPTION OF THE DRAWINGS

FIG. 1 is a block illustration of a television set connected to a plurality of peripheral devices.

FIG. 2 is a flow diagram of a method of adjusting an electronic device.

FIG. 3 is an illustration of a television image including an exemplary menu of input signal sources.

FIG. 4 is an illustration of a television image including an exemplary menu of settings corresponding to a selected signal source.

FIG. 5 is an illustration of a television image including an exemplary menu of control levels selectable by a user.

FIG. 6 is an illustration of a television image including an exemplary menu of adjustment controls for a user selected input source and control level.

### DETAILED DESCRIPTION OF PREFERRED EMBODIMENTS

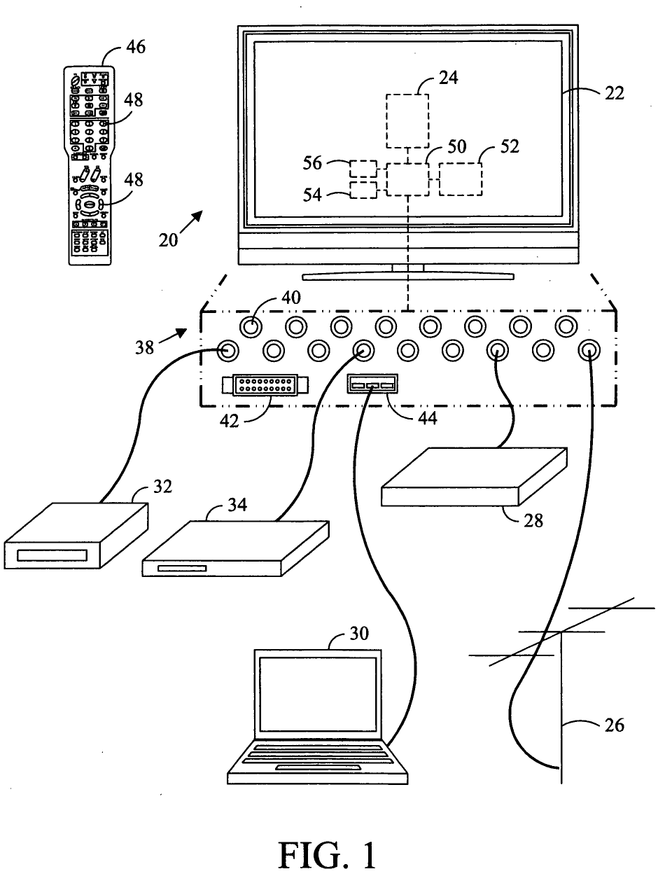

Referring in detail to the drawings where similar parts are identified by like reference numerals, and, more particularly to FIG. 1, a television set (TV) 20 comprises a display 22 and a receiver 24 for over-the-air television broadcasts. IN the pas, over-the-air television broadcasts have been transmitted, in a plurality of transmission bands, with analog signals but are commonly transmitted with digital signaling. The broadcast television input signal may be derived from an antenna 26 and/or from a cable and/or satellite receiver that may either be built-in to the television set or in a set top box 28 attached to the TV. In addition, television sets often provide the audio and video output for a variety of non-broadcast sources. By way of examples, a TV may be connected to a personal computer (PC) 30, a personal video recorder (PVR) 32, a digital versatile disk (DVD) player 34, a video cassette recorder (VCR), a video game console and other devices that output an analog or digital audio and/or video signal. These devices are commonly physically separate from the television set and connected to the TV by one or more cables. The exemplary television set includes an input/output panel 38, on the back of the television set, that includes a number of connectors of a plurality of types 40, 42, 44 to accommodate connecting a plurality of input devices having connections with differing specifications. For examples, connectors may provided for coaxial cable, audio/video (A/V) cable; composite video cable; super video (S-video) cable; component (Y, P_{b}, Pᵣ) video cable; red, green, blue (RGB) video cable; IEEE (Institute of Electrical and Electronics Engineers, Inc.) 1394 cable and fiber optic cable.

As television sets have become a general purpose audio and video output device, it has become increasingly complicated to set up and adjust the TV for optimum performance when connected to a particular set of input signal sources chosen by an individual user. The present inventors concluded that set up and adjustment of TVs and other consumer electronic devices connectible to a plurality of input sources could be simplified if the set up and adjustment procedure for the device could be correlated to each source of the input signal. For example, adjustment of a different set of operating parameters is desirable if the TV is serving as an output for the signals of PC than when the TV is displaying analog, broadcast, television signals. Likewise, the performance of input devices may vary by manufacturer and model and a set up and adjustment procedure enabling the user to fine tune settings of the operating parameters of the TV to a particular input device and the user's personal taste can optimize the viewing experience. However, while certain users may seek a high level of control over the operation of the TV, other users find the ability to adjust a large number of operating parameters confusing and frustrating. These users are more willing to accept recommended settings reflecting the judgment of the TV's manufacturer concerning the TV's performance that most satisfactory to most viewers. The inventors concluded that frustration with the set up and adjustment of a television set could be reduced by enabling users to decide the level of control to be exerted over the available adjustments and displaying a set up and adjustment interface which is appropriate for the input source and the level of control that the user seeks to assert.

The operation of the television set 20 is controlled through a remote control 46 comprising a user interface that includes a plurality of control elements 48 that can be manually actuated by the user. Actuation of appropriate control elements causes the remote control to signal a controller 50 in the television set to change television channels, increase or decrease the volume of the audio output and display a plurality of menus that enable the user to select and operate a number of features related to the video and audio television output, such as captioning and displaying the time.

A television remote control may be specific to the particular model of TV or a universal remote control enabling the user to control, in addition to the television, a wide range of peripheral devices that may connected to the TV. By inputting a numerical code representing the manufacturer and the model of the peripheral device the user can cause the remote control to output signals appropriate to the user's particular peripheral devices, for example a DVD player. When a control element of the remote control is actuated, the remote control locates the proper output signals in its memory for the particular the make and model of peripheral device represented by the numerical code and outputs an appropriate signal to control a function of the peripheral device.

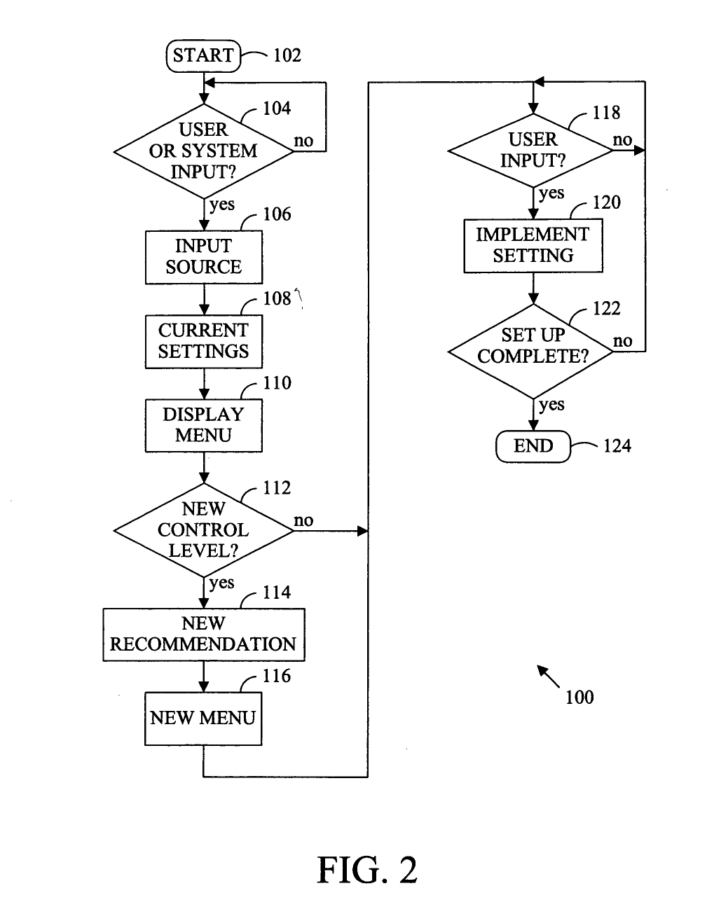

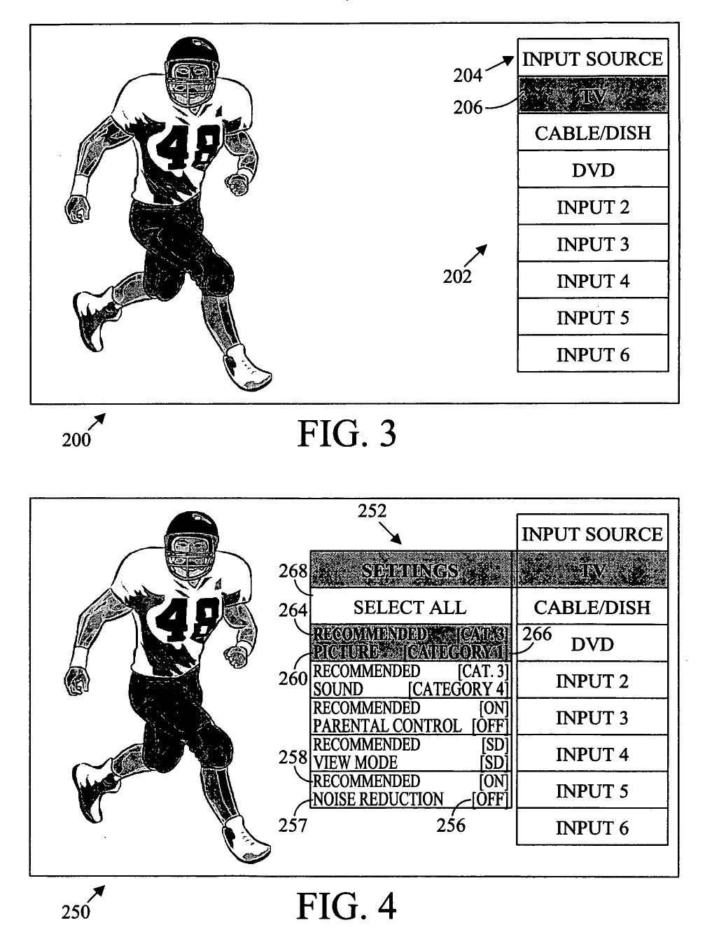

Set up and adjustment of the television set 20 are accomplished through user interaction with the control elements of the remote control and with virtual controls represented by elements of menus that are displayable on the TV. By operating control elements of the remote control, the user can cause the TV to display set up and adjustment menus, navigate through the menus and input adjustment data to the controller that controls the operation of the television. Referring to FIG. 2, the user can initiate 102 the set up and adjustment procedure 100 by actuating a control element on the remote control that instructs the television to display a menu screen. On the other hand, the television can initiate the procedure when it is first powered up or when a new input source is detected 104. Referring to FIG. 3, an initial set up and adjustment menu screen 200 includes a menu 202 comprising a plurality of menu elements 204 enumerating the sources of input signals that are connected to the TV and/or the input connections available for connecting additional peripheral devices to the TV. As additional input sources are connected to the TV, the user can replace the generic labels in the menu indicating an available connection, for example INPUT 2, with a label descriptive of the device that is connected to that input. By operating movement control elements and a selection control element on the remote control, the user can cause menu element for an input signal source, for example, the menu element for the antenna (TV) 206, to be highlighted in the menu and selected to further enable adjustment of the operating parameters of the television set that are appropriate in the context of the specific input signal source, over-the-air broadcast signals received through an antenna.

When a menu item, for example TV, is selected, the controller queries a memory 52 and determines the settings that are currently in effect for the various operating parameters that are adjustable when the television set is receiving signals derived from the specific source 108, for example an over-the-air broadcast television signal derived from the antenna. When new sources of input signals are connected to the television, settings data is typically down loaded and input to the memory. The data may be downloaded from a removable medium, such as a PC card, supplied by the peripheral device manufacturer engageable with a port 54 in the TV. The TV may be connected to a network, such as the World Wide Web, through a wireless or a wired communications port 56 enabling adjustment data to be downloaded to the TV's memory from, for example, a manufacturer's web site. In some cases, the connection of a peripheral device to the TV can be detected by the TV and adjustment data can be automatically sought by the controller and downloaded to the TV's memory from a memory in the peripheral device.

Referring to FIG. 4, the controller selects and displays an image 250 including a settings menu 252 that is appropriate for the input source and the level of control currently selected by the user and which includes the data for the current settings 110. The user can maneuver through the elements of the settings menu by actuation of the movement control elements on the remote control. The menu elements of the settings menu include an identification of an operating parameter group 260, for example the operating parameter group PICTURE, that can be adjusted as a group by selecting the menu element and entering appropriate setting data. The menu element also indicates the current setting 266 for the operating parameter group and the setting recommended by the manufacturer 264. The user can change an current group setting by replacing the current setting with the a new setting or can accept the recommended setting by depressing a control element when the menu element for the group is highlighted. On the other hand, the user can highlight and select the SELECT ALL menu element 268 to accept all of the recommended settings for all of the groups contained in the displayed menu.

Television users have varying desires to exert control over the individual operating parameters of the television. Some users desire to exert control over many of the individual operating parameters that are adjustable for a particular input source to optimize the performance of the TV to satisfy their personal taste or to adjust the TV for better performance with a particular source of the input signal, for example a particular make and model of a peripheral device. On the other hand, many users are content to accept the manufacturer's recommended settings which often represent a compromise that is deemed satisfactory by large group of users. Other users may desire to adjust some of the more important operating parameters, but not be bothered with reviewing all of the possible adjustments.

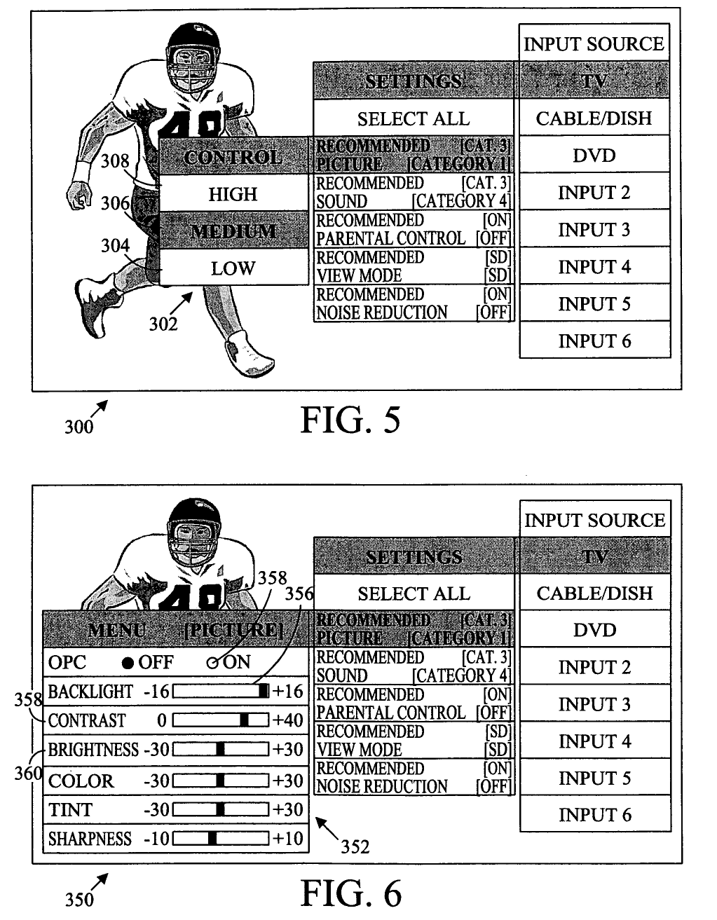

Referring to FIG. 5, when the user of the exemplary TV 20, selects a settings category, such as PICTURE, an image 300 including a control level menu 302 is displayed. By actuating the proper control elements on the remote control, the user can highlight and select the control level that the user feels is appropriate to his/her desires. For example, at a low level of control 302 the user may be satisfied with a group adjustment enabled from the settings menu. On the other hand, referring also to FIG. 6, by selecting a medium level of control 304, the user can cause the TV to display an image 350 enabling access to an picture adjustment menu 352 comprising a number of operating parameters that can be individually adjusted to further refine or customize the video display to satisfy the user's taste. The exemplary picture adjustment menu includes virtual iconic toggle 354 and slider 356 control elements enabling the user to adjust, for examples, the contrast 358 or brightness 360 of the picture. As the level of control selected by the user increases, adjustment is enabled for individual operating parameters that were not individually adjustable at a lower level of control. For example, the exemplary control level menu includes three control levels, LOW, MEDIUM and HIGH. The MEDIUM control level permits individual adjustment of operating parameters that are not individually adjustable at the LOW control level and the HIGH control level, selectable by selection of the menu element 308, enables individual adjustment of operating parameters that are not individually adjustable at the MEDIUM control level. A greater or lesser number of control levels can be provided and adjustments enabled at any level of control can be varied, as desired.

If the user does not select a new control level 112, the adjustment procedure continues to display the current menu and await the user's selection of a displayed operating parameter. When the user adjusts an operating parameter or selects all of the recommended adjustments, the controller updates the setting for the affected control parameter(s) 120 and determines if additional parameters are to be adjusted 122. If all of the operating parameters displayed in the menu have been adjusted, the procedure ends 124. If all of the operating parameters in the on-screen menu have not been selected 122, the system waits for the next user input 118.

If the user selects a new control level 112, the controller determines the operating parameters to be displayed in a new menu and determines any recommended settings for operating parameters that have not already been established by the user and which will be displayed in the new menu 114. The new menu appropriate to the context of the source of input signals and the control level selected by the user is then displayed 116 enabling the user to input the desired adjustments.

Context relevant controls for a electronic device, such as a television, connectible to a range of input signal sources enables the device's user to assert a level of control over the device that is comfortable to the user and to customize the performance of the device to respond to the particular input source.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. A method for adjusting an electronic device comprising the steps of:
(a) enabling an adjustment control facilitating independent adjustment of an operating parameter of said electronic device if independent adjustment of said operating parameter is permitted at a user specified level of control of said device; and
(b) not enabling said adjustment control if independent adjustment of said operating parameter is not permitted at said user specified level of control of said device.

2. A method for adjusting an electronic device comprising the steps of:
(a) selecting one of a first level of control and a second level of control of said device, said second level of control permitting independent adjustment of an operating parameter of said device that is not independently adjustable when said first level of control is selected;
(b) displaying a user interface comprising an adjustment control enabling independent adjustment of said operating parameter if said second level of control has been selected; and
(c) displaying a user interface that does not include an adjustment control for independent adjustment of said operating parameter if said first level of control has been selected.

3. The method for adjusting an electronic device of claim 2 wherein said electronic device comprises a television set.

4. A method for adjusting a television set comprising the steps of:
(a) selecting one of a plurality of sources of an input signal for said television set;
(b) selecting one of a first level of control and a second level of control of said television set, said second level of control permitting independent adjustment of an operating parameter of said television set that is not independently adjustable if said first level of control is selected;
(c) displaying a first user interface comprising an adjustment control enabling independent adjustment of said operating parameter if said second level of control has been selected and if adjustment of said operating parameter is permitted when an input signal to said television set is derivable from said selected source; and
(d) displaying a second user interface that does not include an adjustment control enabling independent adjustment of said operating parameter if at least one of said first level of control has been selected and adjustment is not permitted when an input signal is derivable from said selected source.

5. The method for adjusting a television set of claim 4 wherein the step of selecting a source of an input signal for said television set comprises the step of selecting a type of source from which an input signal to a television set may be derived.

6. The method for adjusting a television set of claim 4 wherein the step of selecting a source of an input signal for said television set comprises the step of selecting at least one of a manufacturer and a manufacturer's designation of a source from which an input signal to a television set may be derived.

7. The method for adjusting a television set of claim 4 wherein the step of selecting a source of an input signal for said television set comprises the step of selecting a source an analog input signal.

8. The method for adjusting a television set of claim 4 wherein the step of selecting a source of an input signal for said television set comprises the step of selecting a source a digital input signal.

9. The method for adjusting a television set of claim 4 wherein the step of displaying a first user interface comprising an adjustment control enabling independent adjustment of said operating parameter comprises the step of displaying a menu including a menu element selectable by interaction of a user and a remote control for said television, a value of said operating parameter alterable by selection of said menu element.
